(19) United States
(12) Patent Application Publication
(10) Pub. No.: US 2009/0177631 A1
(43) Pub. Date: Jul. 9, 2009

(54) Data providing device, method for providing data, and recording medium

(75) Inventor: Toshikazu Ohwada, Tokyo (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/318,566

(22) Filed: Dec. 31, 2008

(30) Foreign Application Priority Data
Jan. 9, 2008 (JP) 2008-002590

(51) Int. Cl. G06F 17/30

(52) U.S. Cl. 707/3; 707/E17.014

(57) ABSTRACT

A data providing device connected via a network to a data processing device and a data storage server storing data which is continuously updated. The data providing device includes a receiving unit configured to receive one or more search conditions for searching data to be provided to the data processing device, a first data providing unit configured to extract data to be provided to the data processing device from the data storage server based on the one or more search conditions, and a second data providing unit configured to provide data on synchronization between the data stored in the data storage server and data for search corresponding to the data stored in the data storage server to the data processing device.

### PRIORITY STATEMENT

The present patent application claims priority from Japanese Patent Application No. 2008-002590, filed on Jan. 9, 2008 in the Japan Patent Office, the entire contents of which are hereby incorporated herein by reference.

### BACKGROUND

1. Technical Field

Illustrative embodiments generally relate to a data providing device, a method for providing data, and a recording medium recording a program for causing a computer to perform the method for providing data, for use in a data management system in an electronic system.

2. Description of the Related Art

With widespread use of database systems, various attempts have been made to improve accuracy and convenience of data searches and increase search speed. One of those attempts includes a technique in which a search database is used in addition to a main database to search data.

For example, published unexamined Japanese Patent Application No. (hereinafter referred to as JP-A-) 2000-339333 discloses a natural language search support system in which an auxiliary search database called an index database is used in addition to an existing database, without including natural language data to assist natural language search.

Another example database system, disclosed in JP-A-2000-082043, uses an authentication database in addition to an existing OS database used for authentication. Because the authentication database includes data generated by the existing OS database, reliability of the authentication system is improved.

Further, Japanese Patent No. 3126225 discloses a database system in which multiple databases are used to alternately perform delay update so that light and heavy processing is performed in parallel.

However, in the above-described database systems in which a search database is used in addition to an existing main database, data is registered in the main database and must be synchronized with the search database. Consequently, a problem may arise in that data registered in the main database does not exist in the search database before synchronization is completed, that is, the data cannot be searched.

Although a method for reducing the time required for synchronization between the main database and the search database is disclosed in JP-A-2000-339333, the search database is still required to be synchronized with the main database or the data will be inconsistent. Further, inconsistency of data between the main database and the search database may also arise due to synchronization failure.

However, because such database inconsistencies are not reported to a user, unreliable search results may be inadvertently provided to the user.

### SUMMARY

In view of the foregoing, illustrative embodiments provide a data providing device capable of providing data on synchronization to a user so that the user can easily determine whether or not search results are reliable, and limiting search as needed. Illustrative embodiments further provide a method for providing data, and a recording medium recording a program for causing a computer to perform the method for providing data.

At least one embodiment provides a data providing device connected via a network to a data processing device and a data storage server storing data which is continuously updated. The data providing device includes a receiving unit configured to receive one or more search conditions for searching data to be provided to the data processing device, a first data providing unit configured to extract data to be provided to the data processing device from the data storage server based on the one or more search conditions, and a second data providing unit configured to provide data on synchronization between the data stored in the data storage server and data for search corresponding to the data stored in the data storage server to the data processing device.

At least one embodiment provides a method for providing data via a network to a data processing device. The method for providing data includes receiving one or more search conditions for searching data to be provided to the data processing device, extracting data to be provided to the data processing device from a data storage server in which data stored therein is continuously updated based on the one or more search conditions, and providing data on synchronization between the data stored in the data storage server and data for search corresponding to the data stored in the data storage server to the data processing device.

At least one embodiment provides a computer-readable recording medium on which is recorded a program for causing a computer to perform the method for providing data described above.

Additional features and advantages of the illustrative embodiments will be more fully apparent from the following detailed description, the accompanying drawings, and the associated claims.

### BRIEF DESCRIPTION OF THE DRAWINGS

A more complete appreciation of illustrative embodiments and the many attendant advantages thereof will be readily obtained as the same becomes better understood by reference to the following detailed description when considered in connection with the accompanying drawings, wherein:

FIG. 1 is a block diagram of a data management system;

FIG. 2 is a block diagram of the data management system including a data providing device according to a first illustrative embodiment;

FIG. 3 is a view illustrating an example of a screen displayed on a search interface when synchronization is successfully completed;

FIG. 4 is a view illustrating another example of the screen displayed on the search interface in which a warning message indicating incomplete synchronization is displayed;

FIG. 5 is a view illustrating yet another example of the screen displayed on the search interface in which no search is available;

FIG. 6 is a view illustrating yet other example of the screen displayed on the search interface in which a part of a search is not available;

FIG. 7 is a flow chart illustrating a process of updating data in the data management system; and

FIG. 8 is a flow chart illustrating a process of searching data in the data management system.

The accompanying drawings are intended to depict illustrative embodiments and should not be interpreted to limit the scope thereof. The accompanying drawings are not to be considered as drawn to scale unless explicitly noted.

### DETAILED DESCRIPTION OF ILLUSTRATIVE EMBODIMENTS

In describing illustrative embodiments illustrated in the drawings, specific terminology is employed for the sake of clarity. However, the disclosure of this specification is not intended to be limited to the specific terminology so selected, and it is to be understood that each specific element includes all technical equivalents that operate in a similar manner and achieve a similar result.

Reference is now made to the drawings, wherein like reference numerals designate identical or corresponding parts throughout the several views.

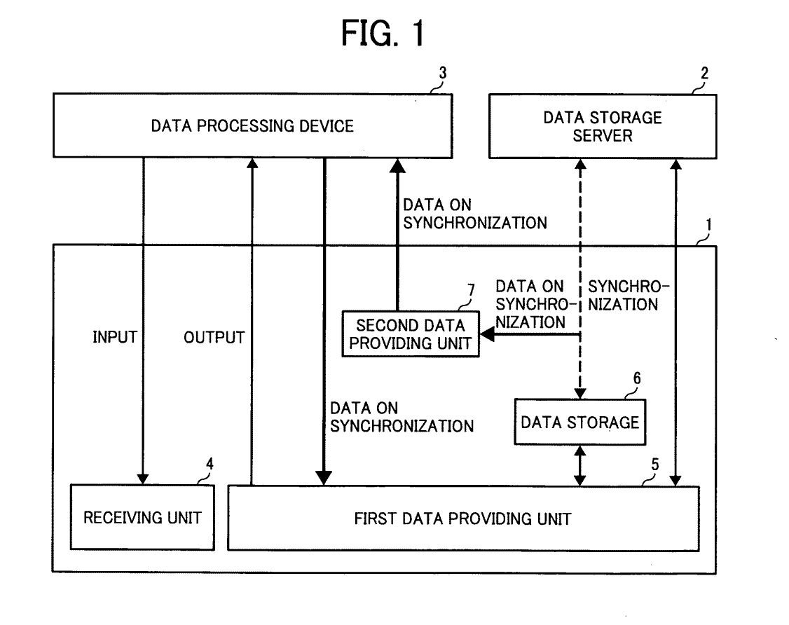

FIG. 1 is a block diagram of a data management system. The data management system includes a data providing device 1 according to illustrative embodiments including a receiving unit 4, a first data providing unit 5, a storage unit 6, and a second data providing unit 7. The data providing device 1 is connected to a data storage server 2 and a data processing device 3 via a network.

The data storage server 2 is a database in which data is continuously updated, and synchronized with the storage unit 6 in the data providing device 1. The data processing device 3 is configured to process a variety of data. The receiving unit 4 is an interface configured to receive data input by a user.

The first data providing unit 5 is an interface configured to extract data from the data storage server 2 and output search results. The storage unit 6 stores a subset of the data stored in the data storage server 2. The second data providing unit 7 holds data on synchronization between the data storage server 2 and the storage unit 6.

A distinctive feature of the data providing device 1 is that it provides data on synchronization associated with data search and reliability of search results to the user. For example, when the data storage server 2 is synchronized with the storage unit 6, the second data providing unit 7 holds data indicating that synchronization is performed between the data storage server 2 and the storage unit 6, and sends such data to the data processing device 3 when a search is performed.

The data processing device 3 receives the data sent from the second data providing unit 7, and sends the data to the first data providing unit 5 to indicate the degree of reliability of the search results to be obtained to the user before a search is performed.

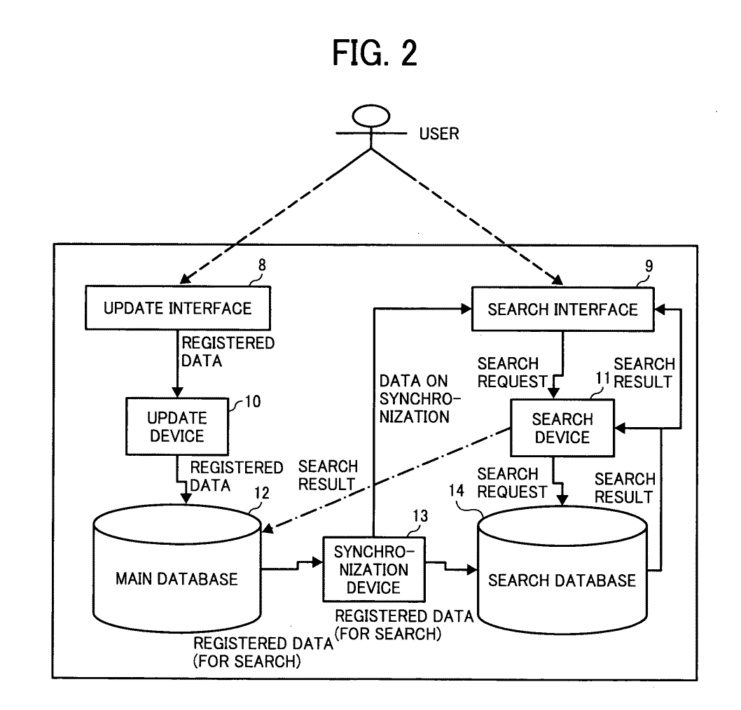

A description is now given of an example of the data management system that includes a data providing device according to a first illustrative embodiment, with reference to FIG. 2.

FIG. 2 is a block diagram of the data management system including a data providing device according to the first illustrative embodiment. The data management system includes an update interface 8, a search interface 9, an update device 10, a search device 11, a main database 12, a synchronization device 13, and a search database 14. The user updates data through the update interface 8, and searches data through the search interface 9. The update device 10 is configured to reflect data received by the update interface 8 in the main database 12.

The main database 12 stores the data. The synchronization device 13 is configured to synchronize the search database 14 with the data registered in the main database 12 and store results of synchronization. The search database 14 stores search data. The search device 11 is configured to search the search database 14 based on search conditions input by the user through the search interface 9. It should be noted that the main database 12 may be used for data search as well as the search database 14. A subset of data and processed data used for search of the data registered by the user through the update interface 8 is registered in the search database 14.

A description is now given of synchronization between the main database 12 and the search database 14 in the data management system.

Synchronization is performed at set times during or after data update. Even if synchronization fails, data is not deleted from the main database 12 because ordinarily synchronization is automatically reattempted after the synchronization device 13 has failed to synchronize the search database 14 with the main database 12. The synchronization device 13 stores data indicating whether or not synchronization has failed as well as the number of pieces of data for which synchronization has failed.

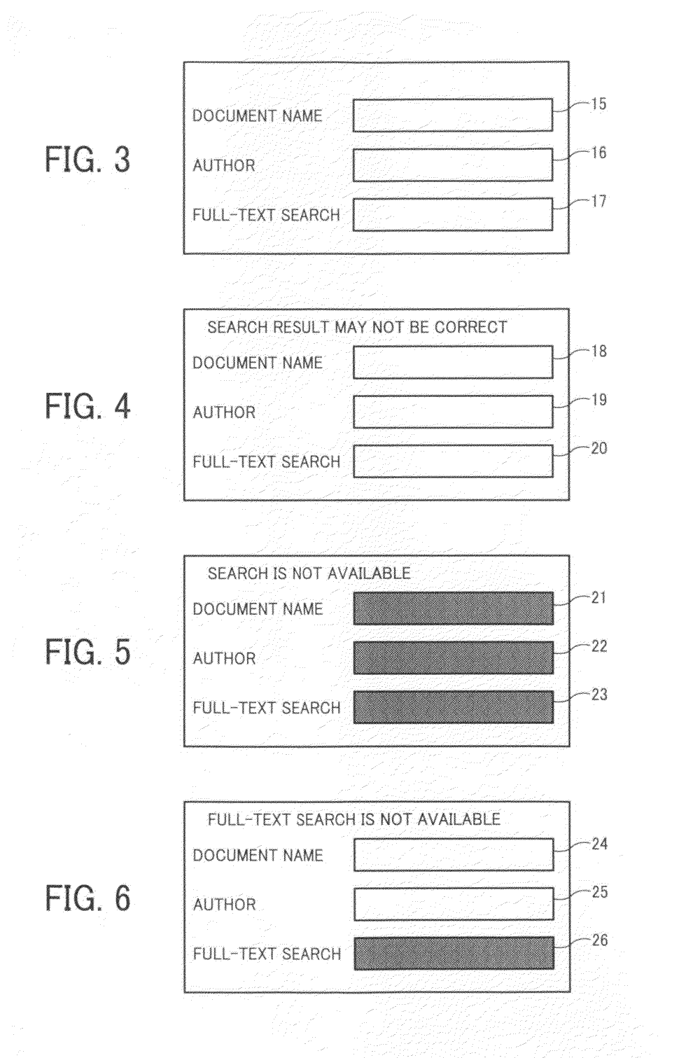

FIG. 3 is a view illustrating an example of a screen displayed on the search interface 9. Here, it is assumed that document data is registered as data for search. The user can input search conditions such as document names, names of authors, and keywords for full-text search in respective input fields 15, 16, and 17. The search database 14 stores data on the above-described search conditions. In general, the screen illustrated in FIG. 3 is displayed on the search interface 9 when synchronization is successfully completed.

Either one of screens illustrated in FIGS. 4 and 5 is displayed on the search interface 9 when synchronization is not completed or has failed. Although a warning message is displayed on the screen illustrated in FIG. 4, the search conditions can be input in respective input fields 18, 19, and 20, that is, data search is still available. By contrast, in the screen illustrated in FIG. 5, input fields 21, 22, and 23 are grayed out so that no search conditions can be input therein, that is, data search is not available. It is necessary to determine in advance whether or not to limit data searches depending on a degree of accuracy of search required for the data management system based on features such as use application and frequency of use.

For example, in a system such as a strategic information system (SIS) which handles real-time data of high value, a screen like that illustrated in FIG. 5 must be displayed to prohibit searches when synchronization is not completed or has failed. However, for example, in a database in which data is updated only once a month or so, it may be satisfactory to display the screen with a warning message like that illustrated in FIG. 4. Thus, the degree of limitation on searches is flexible and can be adjusted as appropriate.

During a search, the data management system checks the synchronization device 13 to obtain data on synchronization. As described above, when synchronization is incomplete or has failed, the screen with the warning message as illustrated in FIG. 4 or the screen with the input limitations as illustrated in FIG. 5 is displayed on the search interface 9. By contrast, when synchronization is successfully completed, the normal screen as illustrated in FIG. 3 is displayed on the search interface 9.

The user inputs the search conditions in the enabled input fields. The search device 11 searches the search database 14 based on the search conditions input by the user, and provides the search results to the user through the search interface 9.

In the foregoing illustrative embodiment, because data on the document names and the names of the authors and data for full-text search is stored in the search database 14, only the search database 14 is used for data search as described above.

A description is now given of a case in which data on the document names and the names of the authors is stored in the main database 12 and data for full-text search is stored in the search database 14.

In such a case, the main database 12 is used for searching the document names and the names of the authors, whereas the search database 14 is used for full-text search. In general, full-text search takes longer because data for the full-text search has a larger file size. Further, a particular technique is often required to limit the search results of full-text search. Accordingly, only data for full-text search is stored in the search database 14, so that only the search database 14 is used for full-text search.

A case in which synchronization between the main database 12 and the search database 14 has failed is described in detail below. In such a case, a screen like that illustrated in FIG. 6 may be displayed on the search interface 9 as well as the screens illustrated in FIGS. 4 and 5, respectively.

Because the main database 12 is continuously updated, the accuracy of data in the main database 12 is reliable. Therefore, data search based on the document names and the names of the authors can be properly performed. However, when synchronization between the main database 12 and the search database 14 has failed, it is not preferable to perform full-text search because unreliable search results may be provided. Consequently, to disable full-text search, an input field 26 for full-text search is grayed out while input. fields 24 and 25 are enabled as illustrated in FIG. 6. By controlling search limitations based on various situations as described above, reliability of the search results can be improved while maintaining search availability.

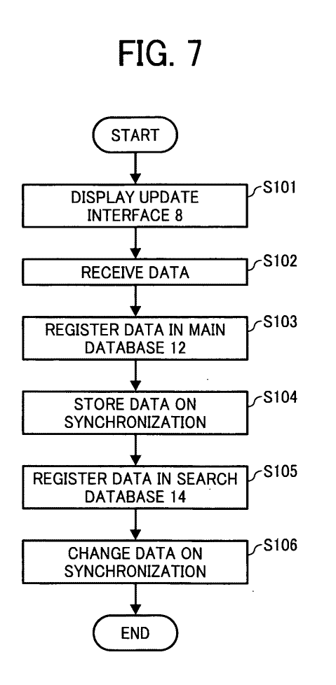

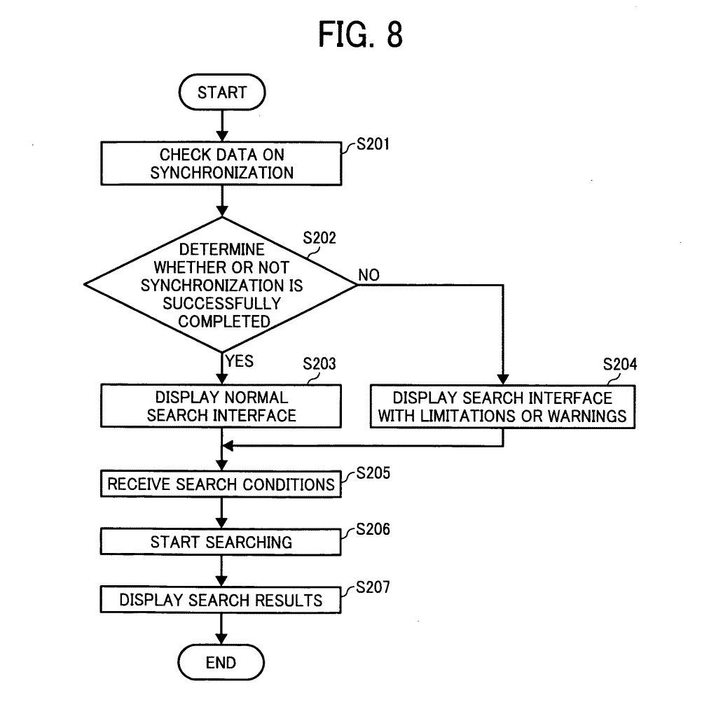

A description is now given of operation of the data management system when data is updated and searched, with reference to the flow charts shown in FIG. 7 and FIG. 8.

FIG. 7 is a flow chart illustrating a process of updating data in the data management system. When the main database 12 is updated, at S101, the update interface 8 is displayed to the user to prompt the user to input data. At S102, the update device 10 receives the data input by the user, and at S103, the data is registered in the main database 12. The synchronization device 13 monitors update of data in the main database 12, and starts synchronization between the main database 12 and the search database 14 at a predetermined time or each time after update of data.

When synchronization is started, at S104, the synchronization device 13 stores data indicating that synchronization is performed between the main database 12 and the search database 14. At S105, the synchronization device 13 reflects data updated in the main database 12 and associated with the search database 14 in the search database 14. When synchronization is completed, at S106, the synchronization device 13 changes the data stored therein to data indicating whether synchronization is successfully completed or has failed. When synchronization has failed, the synchronization device 13 keeps the data indicating that synchronization is performed between the main database 12 and the search database 14 and reattempts synchronization.

A process of data search in the data management system is described in detail below with reference to FIG. 8. FIG. 8 is a flow chart illustrating a process of searching data in the data management system.

During data search, at S201, the data management system checks the synchronization device 13 to obtain data on synchronization. At S202, the data management system determines whether or not synchronization is successfully completed. When synchronization is not completed or has failed (NO at S202), at S204, either the screens with the warning message or the input limitations as illustrated in FIGS. 4 and 5 are displayed on the search interface 9.

When synchronization is successfully completed (YES at S202), at S203, the normal screen as illustrated in FIG. 3 is displayed on the search interface 9. Thereafter, at S205, the search device 11 receives the search conditions input by the user. At S206, the search device 11 searches the search database 14 (and the main database 12 as needed) based on the search conditions thus received, and at S207, provides the search results to the user through the search interface 9.

According to the foregoing illustrative embodiments, when there is a possibility that synchronization between the databases produces unreliable search results, the data management system provides an indication of the degree of reliability of the search results to the user before the user starts searching data. In addition, either the screens illustrated in FIG. 5 or in FIG. 6, in which a part or all of the input fields are grayed out, is displayed to limit data search.

It is to be noted that illustrative embodiments may be implemented as a program. As a result, a system capable of providing an indication of a degree of reliability of the search results to the user as described above can be achieved in a variety of environments.

The above-described program can be stored on a recording medium. Specifically, the program can be stored on a variety of recording media and installed in a variety of environments.

Moreover, illustrative embodiments are not limited to those described above, and various modifications and improvements are possible without departing from the scope of the present invention. It is therefore to be understood that, within the scope of the associated claims, illustrative embodiments may be practiced otherwise than as specifically described herein. For example, elements and/or features of different illustrative embodiments may be combined with each other and/or substituted for each other within the scope of the illustrative embodiments.

What is claimed is:

1. A data providing device connected via a network to a data processing device and a data storage server storing data which is continuously updated, the data providing device comprising:
a receiving unit configured to receive one or more search conditions for searching data to be provided to the data processing device;
a first data providing unit configured to extract data to be provided to the data processing device from the data storage server based on the one or more search conditions; and
a second data providing unit configured to provide data on synchronization between the data stored in the data storage server and data for search corresponding to the data stored in the data storage server to the data processing device.

2. The data providing device according to claim 1, further comprising a storage unit configured to store a subset of the data stored in the data storage server,
wherein:
the first data providing unit extracts data to be provided to the data processing device from the data storage server based on the subset of the data stored in the storage unit as well as the one or more search conditions; and
the second data providing unit provides data on synchronization between the data stored in the data storage server and the subset of the data stored in the storage unit to the data processing device.

3. The data providing device according to claim 1, wherein the second data providing unit further provides data for prompting a user to input an instruction to search data as well as the data on synchronization.

4. A method for providing data via a network to a data processing device, the method for providing data comprising:
receiving one or more search conditions for searching data to be provided to the data processing device;
extracting data to be provided to the data processing device from a data storage server in which data stored therein is continuously updated based on the one or more search conditions; and
providing data on synchronization between the data stored in the data storage server and data for search corresponding to the data stored in the data storage server to the data processing device.

5. The method for providing data according to claim 4, further comprising storing a subset of the data stored in the data storage server,
wherein:
data to be provided to the data processing device is extracted from the data storage server based on the subset of the data stored in the storage unit as well as the one or more search conditions; and
data on synchronization between the data stored in the data storage server and the subset of the data stored in the storage unit is provided to the data processing device.

6. The method for providing data according to claim 4, wherein data for prompting a user to input an instruction to search data is provided as well as the data on synchronization.

7. A computer-readable recording medium on which is recorded a program for causing a computer to perform the method for providing data according to claim 4.
